(19) United States
(12) Patent Application Publication
(10) Pub. No.: US 2007/0217375 A1
(43) Pub. Date: Sep. 20, 2007

(54) Method for requesting wireless services with a single reusable identifier

(75) Inventors: Geoffrey R. Zampiello, Norwalk, CT (US); James Forsyth, Royal Oak, MI (US); Jonathan Martin, Middletown, CT (US); F.W. Frinder, Brewster, NY (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/384,622

(22) Filed: Mar. 20, 2006

(51) Int. Cl. H04Q 7/24

(52) U.S. Cl. 370/338

(57) ABSTRACT

An apparatus and method (300) are disclosed for requesting wireless services with a single reusable authorization code. An apparatus that incorporates teachings of the present disclosure may include, for example, a network management system (NMS) (102) having a controller (108) that manages operations of a communications interface (104) that communicates with wireless access points (WAPs) (114) in a communication system (100). The controller can be programmed to receive (304) from a wireless communication device (WCD) (116) a request for service with a select one of the WAPs, determine (306) from the request an identity associated with the WCD, determine (316) from the identity one or more service attributes corresponding to the WCD, and establish (318-324) service between the WCD and the WAP according to the one or more service attributes. Additional embodiments are disclosed.

### FIELD OF THE DISCLOSURE

The present disclosure relates generally to wireless services, and more specifically to a method for requesting wireless services with a single reusable authorization code.

### BACKGROUND

When an end user roams from one service provider to another, it can be burdensome to an end user to memorize more than one set of credentials so as to enable services between service providers. Varying network resources between independent service providers and matching such variations to the capabilities of the end user's communication device can further complicate the authorization process.

Some service providers have attempted to solve this problem by contracting third parties who serve to broker deals with other service providers in order to minimize the number of authorization codes that need to be memorized by the end user when roaming outside of the end user's home network. Such brokerage services are generally managed independently from the end user's home network, and can be costly to the service provider contracting these services. Moreover, the end user still has to memorize an additional set of credentials when roaming outside of the home network.

A need therefore arises for a method to request for wireless services with a single reusable authorization code.

### BRIEF DESCRIPTION OF THE DRAWINGS

FIG. 1 depicts an exemplary embodiment of wireless communication devices (WCDs) communicating by way of wireless access points (WAPs) managed by a network management system (NMS), which collectively operate as a communication system;

FIG. 2 depicts an exemplary embodiment of the WCD;

FIG. 3 depicts an exemplary method operating in portions of the NMS, the WCD, and a corresponding WAP; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for requesting wireless services with a single reusable authorization code.

In a first embodiment of the present disclosure, a network management system (NMS) can have a controller that manages operations of a communications interface that communicates with wireless access points (WAPs) in a communication system. The controller can be programmed to receive from a wireless communication device (WCD) a request for service with a select one of the WAPs, determine from the request an identity associated with the WCD, determine from the identity one or more service attributes corresponding to the WCD, and establish service between the WCD and the WAP according to the one or more service attributes.

In a second embodiment of the present disclosure, a computer-readable storage medium in a network management system (NMS), comprising computer instructions for establishing wireless service between a wireless communication device (WCD) and a wireless access point (WAP) according to one or more service attributes associated with credentials supplied by the WCD.

In a third embodiment of the present disclosure, a method in a wireless communication device (WCD) can have the steps of transmitting to a network management system (NMS) a request for wireless service with a wireless access point (WAP), wherein the request includes an identifier associated with the WCD, and establishing wireless service with the WAP according to provisioning information supplied by the NMS to least one among the WCD and the WAP according to one or more service attributes retrieved by the NMS with the identifier.

In a fourth embodiment of the present disclosure, a method in a wireless access point (WAP) can have the steps of transmitting to a network management system (NMS) a request for wireless service received from a wireless communication device (WCD), wherein the request includes an identifier associated with the WCD, and establishing wireless service with the WCD according to provisioning information supplied by the NMS to least one among the WCD and the WAP according to one or more service attributes retrieved by the NMS with the identifier.

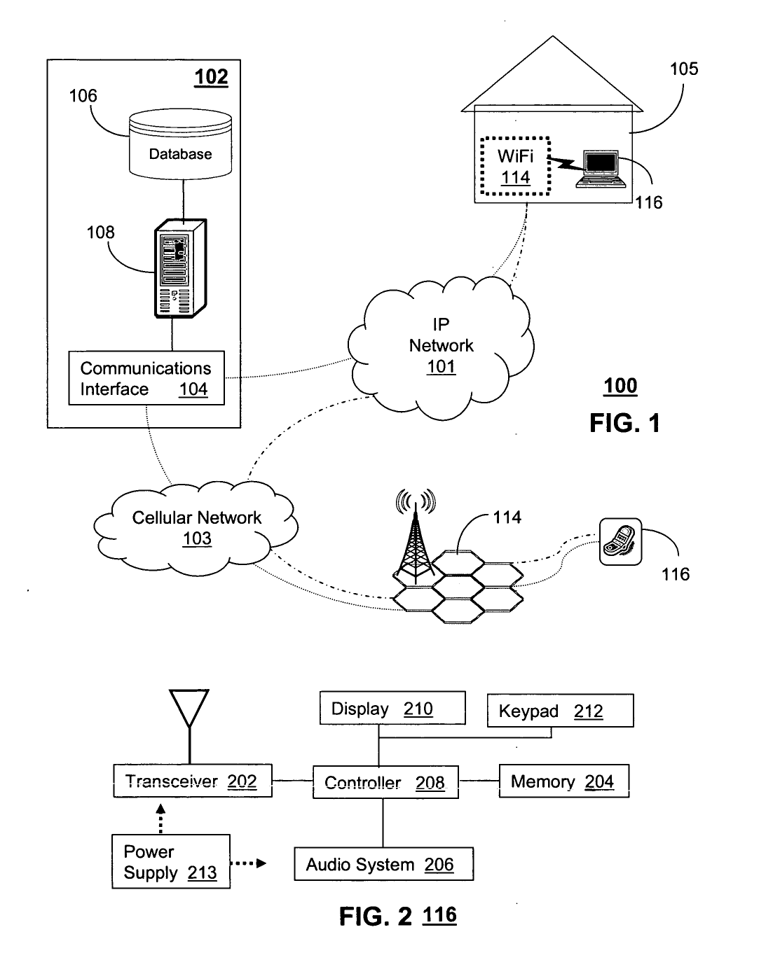

FIG. 1 depicts an exemplary embodiment of wireless communication devices (WCDs) 116 communicating by way of wireless access points (WAPs) 114 managed by a network management system (NMS) 102, which collectively operate as a communication system 100.

The WCD 116 can represent any common computing device (e.g., a cellular phone or laptop) capable of communicating wirelessly with one or more WAPs 114 in the communication system 100. The WAPs 114 of FIG. 1 depict a number of possible embodiments including a plurality of cellular base stations supporting wireless voice and/or data communications in a cellular network 103, and/or one or more Wireless Fidelity (WiFi) access points operating in a commercial enterprise or residence 105.

The cellular network 103 can utilize circuit-switched technology that supports voice and data services such as GSM-GPRS, EDGE, CDMA-1X, EV/DO, UMTS, and other known and next generation cellular communications technologies. The cellular network 103 is coupled to the WAPs 114 according to a frequency-reuse architecture for communicating over-the-air with roaming WCDs 116. WiFi access points can conform to any one of IEEE's 802.11 present and next generation protocols (e.g., IEEE 802.11 a, b, g, n and/or next generation technologies) and can operate individually or in a mesh network.

Alternatively, or in combination, other wireless access technologies can be applied to the present disclosure such as, for example, a Worldwide Interoperability for Microwave Access (WiMAX), ultra wide band (UWB), Bluetooth™, and software defined radio (SDR). SDR allows for accessibility to public and private communication spectrum with any number of communication protocols that can be dynamically downloaded over-the-air. A WAP 114 can also represent a cordless phone base unit coupled to a plain old telephone service (POTS) interface. Other present and future generation wireless access technologies can also be used in the present disclosure.

The communication system 100 can further comprise an IP (Internet Protocol) network 101 that couples the NMS 102 to the WAPs 114 for carrying Internet traffic therebetween. The NMS 102 comprises a communications interface 104 that utilizes common technology for communicating over an EP interface with the IP network 101, and directly with the cellular network 103 with fixed or leased lines. By way of these interfaces, the NMS 102 can control and manage the WAPs 114 operating in a building 105 or the cellular network 103.

The NMS 102 can utilize a memory 106 (such as a high capacity storage medium) embodied in this illustration as a database, and a controller 108 having computing technology such as a desktop computer, or scalable server for controlling operations of the NMS 102. As will be described shortly, the NMS 102 can be programmed to manage wireless services offered to WCDs 116 by way of the WAPs 114.

FIG. 2 is an exemplary block diagram of the WCD 116. In a first embodiment, the WCD 116 can include short range communications technology (such as in a cordless phone) to support mobility within a small area such as the end user's residence or enterprise. Alternatively, the WCD 116 can represent a mobile device utilizing a wireless transceiver 202 that supports mid to long-range wireless communications with the WAPs 114 for exchanging voice and data messages with other targeted mobile devices in the communication system 100. Combinations of these embodiments can also be used to form a multimode communication device (MCD). That is, when the MCD is within the premises of the building 105 it can function as a POTS device, or a Voice over IP (VoIP) device over POTS, WiFi, or Bluetooth™. When roaming outside the building 105, the MCD functions as a wireless communication device operating on the cellular network 103.

Each of the foregoing embodiments for WCDs 116 can utilize a memory 204, an audio system 206, and a controller 208 among other possible functional components. The memory 204 can comprise storage devices such as RAM, SRAM, DRAM, and/or Flash memories. The memory 204 can be external or an integral component of the controller 208. The audio system 206 can be utilized for exchanging audible signals with an end user. The WCD 116 can further include a display 210 for conveying images to the end user, a keypad 212 for manipulating operations of the WCD 116, and a portable power supply 213. The audio system 206, the display 210, and the keypad 212 can singly or in combination represent a user interface (UI) for controlling operations of the WCD 116 as directed by the end user. The controller 208 can manage the foregoing components with computing technology such as a microprocessor and/or digital signal processor.

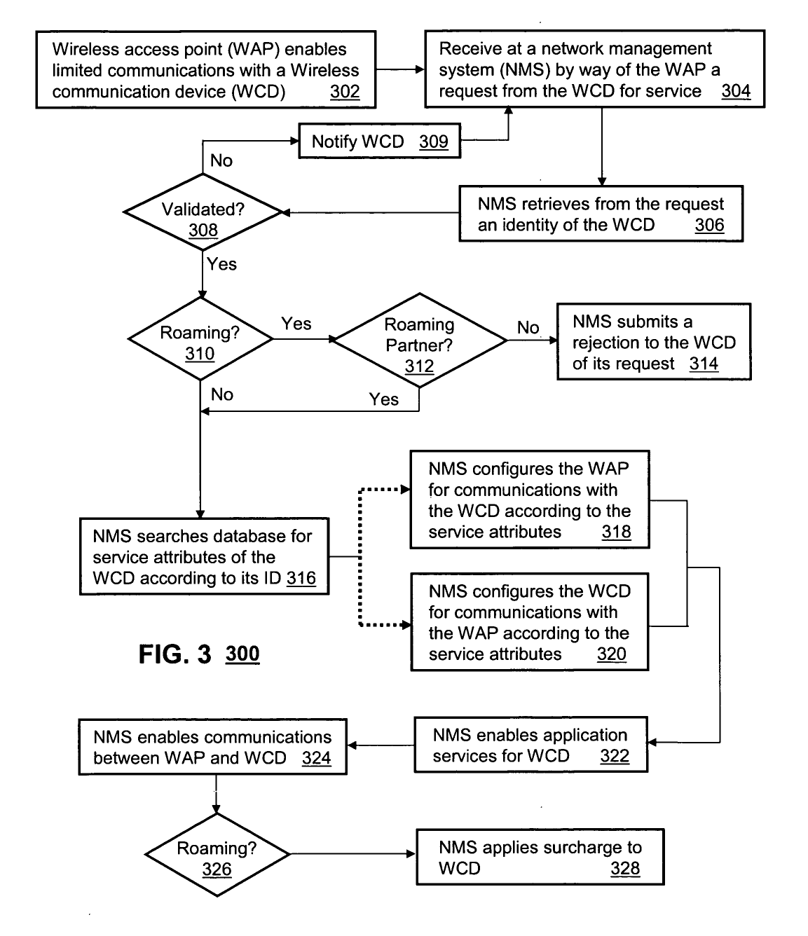

FIG. 3 depicts an exemplary method 300 operating in portions of the NMS 102, the WCD 116, and a corresponding WAP 114. Method 300 illustrates embodiments in which the WCD 116 can acquire services from a WAP 114 in its home network or while roaming. Method 300 begins with step 302 in which a select one of the WAPs 114 enables limited communications with a WCD 116. These communications are sufficient for the WCD 116 to transmit a request for services from the NMS 102 by way of the WAP 114, but limited to the extent that no other actions can be taken by the WCD 116. Upon receiving said request in step 304, the NMS 102 proceeds to step 306 where it retrieves from the request an identity of the WCD 116.

The identity can include credentials of the end user of the WCD 116 such as a login, password, user ID, personal identification number (PIN), or otherwise. The credentials can be processed according to a remote authentication dial in user service (RADIUS) protocol. RADIUS is an Authentication, Authorization and Accounting (AAA) protocol for network access applications or Internet Protocol (IP) mobility, which can be applied in both local and roaming situations.

If NMS 102 determines in step 308 that the credentials of the end user are invalid, it proceeds to step 309 where it notifies the WCD 116 of the failed attempt. Although not shown, the NMS 102 can be programmed for security purposes to accept no more than a certain number of attempts. If the credentials are valid, the NMS 102 proceeds to steps 310-312 where it checks in its database whether the end user is roaming outside of his/her service boundary (i.e., home network) according to an identification of the WAP 114 interfacing to the WCD 116. The identification of the WAP 114 can be its media access control (MAC) address, IP address, serial number, or some other form of suitable identification.

The NMS 102 can utilize a light weight directory access protocol (LDAP) to retrieve information associated with the WAP 114 from its database according to the WAP's ID. LDAP is a software protocol for enabling the NMS 102 to locate network and services information, and other resources such as files and devices in a network, whether on the public Internet or on a corporate intranet. LDAP is a “lightweight” (smaller amount of software code) version of Directory Access Protocol (DAP), which is part of X.500, a standard for directory services in a network.

If the NMS 102 determines in step 310 that the WCD 116 is not roaming, it proceeds to step 316. Otherwise, the NMS 102 proceeds to step 312 where it determines from the information retrieved from its database concerning the WAP 114 whether the WAP belongs to a roaming partner of the service provider of the NMS 102. If the WAP 114 belongs to a roaming partner's network, then the NMS 102 proceeds to step 316; otherwise, it submits a rejection to the WCD 116 in step 314.

If the WCD 116 is not roaming, or is roaming in a roaming partner's network, the NMS 102 proceeds to step 316 where it searches its database for service attributes associated with the WCD 116 indexed by the WCD's credentials. The service attributes retrieved can include information concerning services subscribed by the end user of the WCD 116. Such services can include, for example, bearer service settings such as a speed of communications, a data integrity guarantee, a priority level for contested communication access, and a quality of service (QoS).

Depending on the wireless access technology used by the WAP 114 and/or the WCD 116 one or both of these devices can be configured by the NMS 102 in steps 318-320 for a particular speed of service (e.g., 1, 2, 5.5, 11, 6, 9, 12, 18, 24, 36, 48 or 54 Mbps for an 802.11g WiFi access point). Limiting the speed of communications between the WAP 114 and the WCD 116 frees bandwidth for other WCD end users to gain access to the WAP 114. The NMS 102 can also configure a data integrity guarantee such as by limiting the number of dropped packets (e.g., 0%, 20%, or 40%) in heavy traffic. For a 0% packet drop condition, the NMS 102 can charge a premium service fee, which can be especially helpful in improving voice quality in VoIP applications. The priority level given to the WCD 116 can be useful in situations where there may be more WCDs 116 contesting for services than the WAP 114 has the resources or capacity to handle.

QoS is a general term that can encompass some or all of the foregoing configurable parameters. Generally speaking, QoS describes a network's ability to customize the treatment of specific classes of data. QoS can be used to prioritize, for example, video transmissions over Web-browsing traffic. Advanced networks can offer greater control over how data traffic is classified into classes and greater flexibility as to how the treatment of that traffic is differentiated from other traffic. For example, asynchronous transfer mode (ATM) networks specify modes of service that ensure optimum performance for traffic such as VoIP and video. The primary goal of QoS is to provide priority including dedicated bandwidth, controlled jitter and latency as may be required by some real-time and interactive traffic, and improved loss characteristics.

Once the WCD 116, the WAP 114 and other network elements of the communication system 100 associated therewith have been configured, the NMS 102 proceeds to step 322 where it enables application services for the WCD 116. The application services can include without limitation, VoIP, Internet service, email service, and multimedia services (such as video or audio streaming, IPTV, and so on). The NMS 102 selects the services to offer the WCD 116 according to the service attributes retrieved in step 316. The quality of these services will depend in part on the bearer service settings described above.

Once services have been enabled, the NMS 102 proceeds to step 324 where it enables communications between the WAP 114 and WCD 116 to the extent of the bearer and application services just described earlier. In step 326, the NMS 102 also checks if the services provided are for a roaming use case. If so, the NMS 102 applies in step 328 a surcharge against the WCD's use of such services. The surcharge can be based on the time that such services are used, or a fixed fee.

The present disclosure overcomes the deficiencies in the prior art by providing an end user a single credential that can be applied repeatedly by the end user in his/her home network, and while roaming on partner networks. It would be evident to an artisan with ordinary skill in the art that the foregoing embodiments illustrated by method 300 can be modified, reduced, or enhanced without departing from the scope and spirit of the claims described below. The reader is therefore directed to the claims for the fullest understanding of the breadth and scope of the present disclosure.

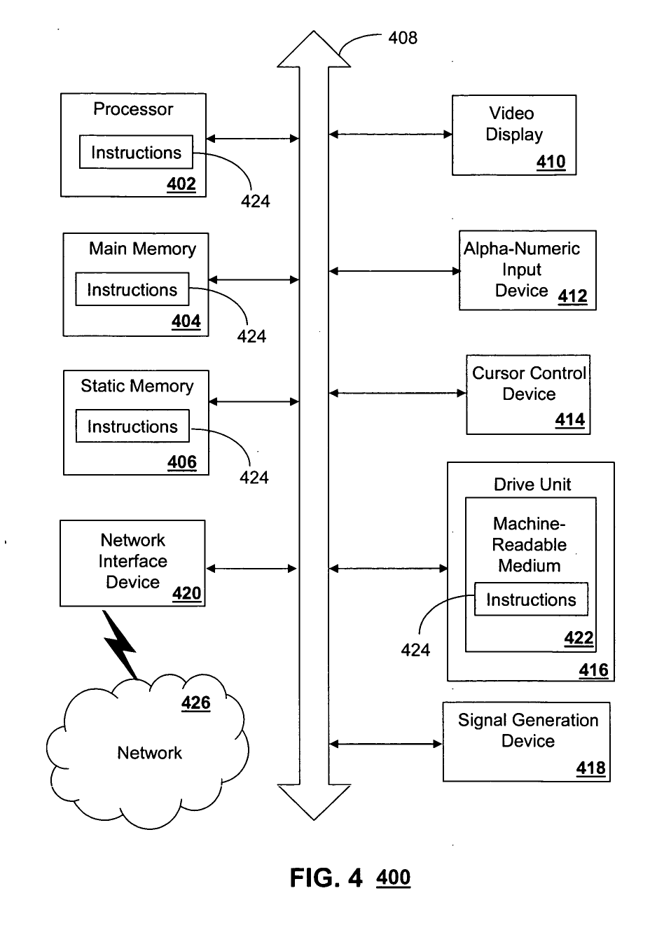

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network management system (NMS), comprising:
a controller that manages operations of a communications interface that communicates with wireless access points (WAPs) in a communication system, wherein the controller is programmed to:
receive from a wireless communication device (WCD) a request for service with a select one of the WAPs;
determine from the request an identity associated with the WCD;
determine from the identity one or more service attributes corresponding to the WCD; and
establish service between the WCD and the WAP according to the one or more service attributes and the wireless service capabilities of the WAP.

2. The NMS of claim 1, wherein the controller is programmed to configure the WAP for communications with the WCD according to the one or more service attributes.

3. The NMS of claim 1, wherein the controller is programmed to configure the WCD for communications with the WAP according to the one or more service attributes.

4. The NMS of claim 1, wherein the one or more service attributes comprise at least one among a group of bearer service settings comprising a speed of communications, a data integrity guarantee, a priority level for contested communication access, and a quality of service (QoS).

5. The NMS of claim 1, wherein the one or more service attributes comprise at least one among a group of application services comprising a roaming service, a Voice over Internet Protocol (VoIP) service, an Internet service, an email service, and a multimedia service.

6. The NMS of claim 1, wherein the WAP comprises at least one among Wireless Fidelity (WiFi) access point, a Worldwide Interoperability for Microwave Access (WiMAX) access point, a Bluetooth™ access point, a software defined radio (SDR) access point, and a cellular access point.

7. The NMS of claim 1, wherein the controller is programmed to search a database of services attributes according to the identity of the WCD.

8. The NMS of claim 7, wherein the database conforms to a Lightweight Directory Access Protocol (LDAP).

9. The NMS of claim 1, wherein the controller is programmed to:
retrieve the one or more service attributes from a database according to the identity supplied by the WCD;
determine from an identity of the WAP whether the WCD is roaming outside of its home network;
if the WAP is outside of the WCD's home network, determine if the WAP is included in a list of roaming partners;
if the WCD is roaming, the WAP is included in the list of roaming partners, and the one or more service attributes indicate the WCD can roam outside of its home network, establish service between the WCD and the WAP according to the one or more service attributes and the wireless service capabilities of the WAP.

10. The NMS of claim 9, wherein the controller is programmed to record a roaming surcharge for the WCD according a usage of wireless services provided by one or more of the plurality of WAPs.

11. The NMS of claim 1, wherein the controller is programmed to receive the request according to a remote authentication dial in user service (RADIUS) protocol.

12. A computer-readable storage medium in a network management system (NMS), comprising computer instructions for establishing wireless service between a wireless communication device (WCD) and a wireless access point (WAP) according to one or more service attributes associated with credentials supplied by the WCD.

13. The storage medium of claim 12, wherein the one or more service attributes comprise at least one among a group of bearer service settings comprising a speed of communications, a data integrity guarantee, a priority level for contested communication access, and a quality of service (QoS), and wherein the storage medium comprises computer instructions for provisioning at least one among the WAP, the WCD, and network elements of a communication system associated therewith according to the one or more service attributes.

14. The storage medium of claim 12, wherein the one or more service attributes comprise at least one among a group of service options comprising a roaming service, a Voice over Internet Protocol (VoIP) service, an Internet service, an email service, and a multimedia service, and wherein the storage medium comprises computer instructions for provisioning at least one among the WAP, the WCD, and network elements of a communication system associated therewith according to the service options.

15. The storage medium of claim 12, wherein the WAP and the WCD operate according to least one among a group of communication protocols comprising Wireless Fidelity (WiFi), Worldwide Interoperability for Microwave Access (WiMAX), Bluetooth™, software defined radio (SDR), and cellular communications, and wherein the storage medium comprises computer instructions for controlling one or more operating parameters of a select one of the communication protocols used by the WAP and the WCD according to the one or more service attributes.

16. The storage medium of claim 12, comprising computer instructions for searching a database of service attributes according to the credentials of the WCD, wherein the database conforms to a Lightweight Directory Access Protocol (LDAP).

17. The storage medium of claim 12, comprising computer instructions for recording a roaming charge for the WCD when the WAP providing wireless services is outside a service boundary.

18. The storage medium of claim 12, comprising computer instructions for authenticating the WCD according to its identity.

19. A method in a wireless communication device (WCD), comprising:
transmitting to a network management system (NMS) a request for wireless service with a wireless access point (WAP), wherein the request includes an identifier associated with the WCD; and
establishing wireless service with the WAP according to provisioning information supplied by the NMS to at least one among the WCD and the WAP based on one or more service attributes retrieved by the NMS with the identifier.

20. A method in a wireless access point (WAP), comprising:
enabling limited communications with a wireless communication device (WCD);
transmitting to a network management system (NMS) a request for wireless service received from the WCD, wherein the request includes an identifier associated with the WCD; and
establishing wireless service with the WCD according to provisioning information supplied by the NMS to at least one among the WCD and the WAP based on one or more service attributes retrieved by the NMS with the identifier.
